(19) United States
(12) Patent Application Publication
(10) Pub. No.: US 2016/0041998 A1
(43) Pub. Date: Feb. 11, 2016

(54) Apparatus and Methods for Personalized Video Delivery

(71) Applicant: NFL Enterprises LLC, New York, NY (US)

(72) Inventors: Christopher S. Hall, Playa Vista, CA (US); Cory Mummery, Torrance, CA (US); Timothy Brady, Santa Monica, CA (US)

(21) Appl. No.: 14/452,454

(22) Filed: Aug. 5, 2014

(51) Int. Cl. G06F 17/30

(52) U.S. Cl. CPC G06F 17/3084; G06F 17/30867; G06F 17/3082; G06F 17/30106

(57) ABSTRACT

Computer systems and methods providing personalized delivery of video files to a user's device. A computer server allows a user to create a user profile which includes information about certain user preferences, such as a favorite subject matter, favorite participant(s) and the like and, when a user connects to the computer server, the server checks a video database for video files of potential interest to the user and generates a ranking of video files of potential interest, then provides information and, if requested, the video files, to the user in order of the ranking. The ranking may be based on a variety of inputs, including both express and/or implied user preferences, the elapsed time between the publication (or creation) of a video file and the user's request therefor, the subject matter of the video file, the teams, players, and other persons included in the video file, the length of the video file, and a variety of other information about the video file. The computer server may provide this information and the video files to any one of a number of devices associated with a user, including desktop and laptop computers, tablets, phones, and the like.

### CROSS-REFERENCE TO RELATED APPLICATIONS

N/A

### STATEMENT REGARDING FEDERALLY SPONSORED RESEARCH OR DEVELOPMENT

N/A

### THE NAMES OF PARTIES TO A JOINT RESEARCH AGREEMENT

N/A

### INCORPORATION-BY-REFERENCE OF MATERIAL SUBMITTED ON A COMPACT DISC

N/A

### BACKGROUND OF THE INVENTION

1. Field of the Invention

This invention relates generally to apparatus, systems and methods useful in delivering video information over the Internet to users, and more particularly to apparatus, systems and methods useful in providing suggested video files to users based on a number of factors, which may include recency, primacy, user-expressed preferences, and user-inferred preferences in a way that personalizes the video information delivered.

2. Background of the Invention

Over the last decade or so, there has been a substantial growth in the widespread use of the internet for the delivery of a wide variety of types of information, including for example, news and entertainment. Often, this use of the Internet was via a computer, such as of any conventional type, including personal computers (whether portable or not) at home or at work. In addition, over the last decade, there has been a substantial growth in the use of wireless communications and wireless devices in connection with the delivery of different types of information, also including, for example, news and entertainment. For example, as smartphones have become more conventional for consumer use, such devices have become widely used, not just for email, text messages, and telephone calls, but for wireless communications involving Internet access and browsing, social media, and sending and receiving photographs, audiovisual files, and beyond.

It is conventional for a smartphone to include one or more software programs, often referred to as an application (sometimes referred to as an “app”), that can run on the smartphone and allow the user to access a variety of services. Examples of such applications include applications for Facebook, Twitter, and Instagram for social media, applications for American Express and JPMorgan for financial services and information, applications for CNN, BBC, and ESPN for sports and news, and so forth. In some cases, a smartphone may already include one or more of such applications in its memory when purchased by a customer, or in other cases a smartphone user may choose to install one or more applications, such as by downloading the applications via the Internet for example. Although these examples refer to smartphones, it is conventional for users of tablet computers and similar devices to also install and use (or simply use pre-installed) applications on their devices for a wide variety of types of information.

It is conventional for users of such devices to view video files on their devices. A number of video provider services are available via the Internet, such as YouTube.com, Vimeo, and Vine, for example. Such services typically allow users to create an account which can be used to upload video files to the service's computers, with the service then making the uploaded video available to all via the Internet. Such services may suggest one or more additional videos to a user who has finished watching a video. In addition, a number of news providers or entertainment providers maintain websites accessible via the Internet and from which a user of such a device can view videos, as well as read articles, view photographs, and so forth. Such news and entertainment providers may also suggest articles, photographs, and/or videos based on a user's viewing of a video, review of an article, review of a photograph, or the like, for example. Some conventional Internet sites which provide video information allow a user to connect and obtain information via an Internet browsing software program (such as Google Chrome, Apple Safari, and Microsoft Internet Explorer, for example), in addition to or in lieu of the use of some or all of the phone applications like those noted above.

Some Internet-based video and information services like those mentioned often allow, and sometimes may require, a user to create an account with the service. In some situations, the user may be required to login to the user's account in order to post or upload a video or information, may be required to login in order to access some or all of the content available from the service, and/or may be required to login in order to minimize or eliminate the number or time of advertisements displayed on the user's device before the user is able to access the content requested by the user. In other situations, a service may simply make all content accessible without regard to whether a user has an account or has logged in to an account. In still other situations, a service may use cookies or simply data or software to recognize a user or device that has previously requested content from a service and may then grant access as deemed appropriate for that particular user. Some services also may allow users to subscribe to the service, which subscription may or may not involve a charge, such as to a credit card, bank account, PayPal account, or other payment system. In some situations, such a service may provide a higher level of service or greater access to the subscribing users, such as, for example, providing subscribers with access to more content than non-subscribers, providing access to certain content sooner to subscribers than to non-subscribers, providing priority in terms of allocating bandwidth and responding to subscribers versus non-subscribers, providing subscribers with the ability to download video or otherwise access content in ways not available to non-subscribers, and the like.

Conventional Internet-based services have attempted to find ways to determine the interests of their users and provide suggestions or recommendations of additional content tailored to the interests of the users. For example, some services will ask the users what they prefer or like, such as part of the account creation process. Some services attempt to infer the interests of the users based on a variety of information. For example, U.S. Pat. No. 8,473,500 B2, issued on Jun. 25, 2013 to Baluja et al., and titled “Inferring User Interests,” describes a method of determining label values for users of a social network, with the label values representing an inferred interest level of the users of the social network in subjects indicated by the labels. Similarly, U.S. Pat. No. 8,683,521 B1, issued on Mar. 25, 2014 to Gargi et al., and titled “Feature-Based Video Suggestions,” describes a method and system for generating suggestions of videos by generating values based on the number of times pairs of videos are co-watched, and generating ranking scores of videos in a set of candidate videos, with the highest-ranked videos provided as suggestions for a given video. In U.S. Pat. No. 8,768,958 B1, issued on Jul. 1, 2014 to Baluja et al., and titled “Predictive Information Retrieval,” methods are described by which a server determines, in response to a request for information from a user, one or more predictive follow-up requests for information before actually receiving a follow-up request, and then beginning the retrieval of information for such one or more follow-up requests. We hereby incorporate by reference U.S. Pat. Nos. 8,473,500 B2; 8,683,521 B1; and 8,768,958 B1 as if fully set forth herein.

A variety of conventional approaches exist with respect to placing orders for and paying for a wide variety of goods and services over the Internet. One example is provided by the so-called Amazon.com “one-click” patent, U.S. Pat. No. 5,960,411 issued Sep. 28, 1999 to Hartman et al., which describes systems and methods which allow a vendor system to store information regarding a user, including payment information associated with the user, such as the user's credit card information needed to process a transaction by which the user pays for goods or services for an online order with the credit card, and then allows the user to finalize a transaction ordering goods or services and paying for same with a single click of an icon displayed for confirming the transaction. U.S. Pat. No. 5,960,411 is hereby incorporated by reference as if fully set forth herein.

### SUMMARY OF THE INVENTION

The present disclosure provides computer systems, apparatus, and computer-implemented methods providing personalized delivery of video files to a user's computing device, such as a computer, smartphone, tablet, or other type of device. In one embodiment of the disclosure, a computer server includes software programmed to allow a user to create a user profile which includes information about certain user preferences, such as a favorite subject matter, favorite participant(s) and the like and, when a user connects to the computer server, the server checks the user profile for the user and also checks a video database for video files of potential interest to the user, assigns points to the various video files based on the user profile, and generates a ranking of video files of potential interest to the user, then provides information and one or more of the video files to the user in order of the ranking. In one embodiment, the highest-ranked video file is streamed to the user's device and information (such as a title and screen capture image) regarding a plurality of other video files is sent to the user's device. The ranking of the video files may be based on a variety of inputs, including both express and/or implied user preferences, the elapsed time between the publication of a particular video file and the user's connection to the server or request for the video, the subject matter of the video file, the teams, players, and other persons included in the video file, the length of the video file, and a variety of other information about the video file. In one embodiment of the present disclosure, a computer system for providing video files is disclosed, with the computer system comprising a video database comprising a plurality of video files and information associated with each of the plurality of video files, a user database comprising a plurality of user profiles, each user profile comprising information associated with a corresponding user, at least one computer server in communication with the video database and user database and connected to at least one computer network (which may, for example, include the internet, a wireless cellular telephone network, a WiFi network, and/or other types of networks), and software executable on the computer server, with the software operable to receive requests for information from at least one second computer connected to the network, check to determine if the second computer requesting information is associated with an existing user profile and, if the second computer requesting information is associated with an existing user profile, generate a listing of a plurality of video files of potential interest to a user associated with the user profile, generate a ranking of the video files in the listing based at least in part on the time between the publication of at least one of the video files and the time of the request by the second computer in the network, retrieve information associated with a plurality of the highest ranked video files from the video database, transmit information associated with the plurality of video files to the second computer, and transmit the at least one of the video files to the second computer, such as by beginning to stream the video file to the second computer. In one embodiment, the user profile comprises at least one or more of the following: at least one preselected sports team, at least one preselected person, at least one preselected category of video file, at least one preselected category of subject, information regarding a user's fantasy football team or league, a log of a plurality of video files which have been previously transmitted in whole or in part to a device associated with the user profile and for which a positive response was previously received by the computer server, as well as a log of video files previously transmitted in whole or in part to a device associated with the user profile and for which a negative or neutral response was previously received by the computer server. In another embodiment, the ranking of the plurality of video files is further based at least in part on one or more of the following: the subject matter of the video files, at least one sports team appearing in the video files, and at least one person appearing in the video files, wherein the sports team and the person correspond to a team and a person included in the user profile for the computer requesting the information. In another embodiment, the sports team comprises a professional football team, the person comprises a professional football player, and the subject matter comprises at least one of the following types of subject matter; touchdown, sack, blitz, reception, first down, penalty, interception, fumble, tackle, block, blocked pass, hit, run, score, punt, punt return, kickoff, kickoff return, point after touchdown, pass, field goal, preseason, regular season, playoff, superbowl, or the like. In another embodiment, the ranking of video files is based on assigning different values to different video files based at least in part on one or more categories of subject matter of the corresponding video files and an elapsed time between the publication of each of the video files and the time the second computer requests information from the computer server, with at least one category of subject matter associated with a higher value than at least one other category of subject matter. In yet another embodiment, the second computer is any one of the following types of computing devices: desktop computer, laptop computer, videogame console, tablet, or phone. In another embodiment, the software on the computer server is operable to generate a log of video files and related information most recently transmitted to the second computer and, if the connection between the second computer and the computer server ended while a video file was being played on the second computer, a point during the video file at which the playing of the video file ceased when the connection was ended. In still another embodiment, the video database comprises a first group of video files, wherein the first group of video files comprises video files each of which has a publication date more recent than the other video files stored in the video database and not in the first group of video files, the software executable on said computer server is operable to search the data associated with the first group of video files to generate the ranking of the plurality of video files of potential interest to the user. In addition, one embodiment comprises a computer server which further comprises software operable to receive a first plurality of video files and information regarding the first plurality of video files from one or more authorized computing devices via a computer network (which may be the same as or different than the network used by the second computer mentioned above) and store the first plurality of video files and information regarding the first plurality of video files in said video database. In other embodiments, the first group of video files comprises any of the following ranges of video files: a range of between 50 and 50,000 video files, a range of between 100 and 25,000 video files, and/or a range of between 500 and 1,500 video files.

In another embodiment of the present disclosure, a computer system for viewing video files is disclosed, with the computer system comprising a computing device in communication with a computer network, and having a display, a processor, a memory, and a user input system, software executable on said computing device, with the software operable to transmit a request for information to the network and, via the network, to a computer server, to receive a response from the computer server, wherein if the computing device is associated with an existing user profile accessible by the computer server, the computer server transmits to said computing device a list of a plurality of video files of potential interest to a user associated with the user profile, wherein the list of the plurality of video files is ranked in an order based at least in part on the time between the publication of at least one of the plurality of video files and the time of the request by the computing device, to receive information associated with a plurality of the highest ranked video files from the computer server, and to display the at least one of such video files on said computing device, wherein the computing device may comprise any computing device, including one of the following: desktop computer, laptop computer, videogame console, tablet, or phone. In another embodiment, the software is operable to allow a user to input preference information comprising information about one or more sports teams, one or more players, and/or one or more categories of video files, to transmit the preference information to a computer server for generating a user profile, and operable to receive one or more video files from the computer server responsive to a user profile comprising the preference information.

In another embodiment of the present disclosure, a computer system for providing video files is taught, with the computer system comprising at least one database comprising a plurality of video files, information associated with each of the plurality of video files, and information associated with a plurality of users, at least one computer server in communication with said database and connected to at least one computer network, software executable on the computer server, with the software operable to receive requests for information from at least one second computer in the network, check to determine if the second computer requesting information is associated with an existing user profile stored in the database and, if the second computer requesting information is associated with an existing user profile, generate a ranking of a plurality of video files of potential interest to the user based at least in part on the time between the publication of at least one of the video files and the time of the request by the second computer in the network, retrieve information associated with a plurality of the highest ranked video files from the database, and transmit information associated with the plurality of video files to the second computer. In another embodiment, the software is operable to, in response to a second request from the second computer requesting at least one of such video files, transmit the at least one of the video files requested to the second computer requesting the video file in the network. In another embodiment, the information associated with the plurality of video files further comprises at least a portion of one of the video files and a title associated with the one of the video files. In another embodiment, the database comprises a video database and a user database, wherein said video database comprises a plurality of video files and information associated with the video files stored in non-volatile memory, and wherein said user database comprises information associated with a plurality of users stored in non-volatile memory. In yet another embodiment, the information associated with a plurality of users comprises information regarding user preferences.

Finally, in still other embodiments, computer-implemented methods are disclosed for providing personalized delivery of video files from a database comprising a plurality of video files and information associated with a plurality of users, wherein when a user device connects to a computer server over one or more networks, the server checks to determine if the device is associated with an existing user profile and, if so, checks to see if there is a partially-watched video file associated with that user profile and, if so, begins transmission of that video file to the user, and alternatively or simultaneously, searches a first group of video files with the most recent publication dates for information associated with the user's profile, assigns points to video files based on user preferences and/or user viewing habits and/or other user information stored in the user profile, generates a ranking of the video files based on the points assigned to the video files based on the user preferences, and begins transmitting the highest-ranked video file to the user and/or provide the user with information associated with a number of the next-highest ranked videos (for example, the title, running time, and/or image from the video file), such as the second-highest, third-highest, fourth-highest, and so on, and wherein the number of the next-highest ranked videos for which information is provided depends at least in part on the type of device currently used by the user and connected to the server.

### BRIEF DESCRIPTION OF THE DRAWINGS

FIG. 1 is a schematic diagram of one embodiment of the present disclosure.

FIG. 2 is a flow diagram on some aspects of an embodiment of the present disclosure.

FIG. 3 is a flow diagram of some additional aspects of an embodiment of the present disclosure.

FIG. 4 is a flow diagram of some additional aspects of an embodiment of the present disclosure.

FIG. 5 is an illustration of a screen display which may be provided to a user in accordance with an embodiment of the present disclosure.

FIG. 6 is an illustration of a screen display which may be provided to a user in accordance with an embodiment of the present disclosure.

FIG. 7 is an illustration of a screen display which may be provided to a user in accordance with an embodiment of the present disclosure.

### DETAILED DESCRIPTION OF THE PREFERRED EMBODIMENT

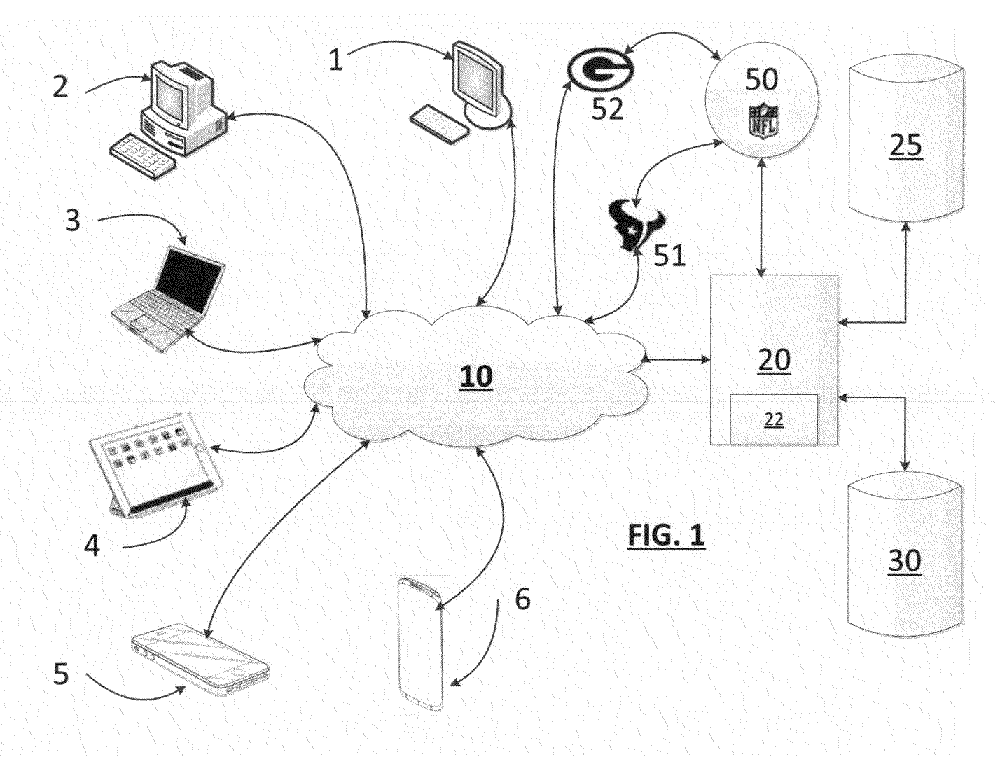

Referring first to FIG. 1, a schematic illustration of one embodiment is provided. In FIG. 1, a plurality of computing devices 1-6 are shown. As illustrated in FIG. 1, the devices 1-6 can be any of a variety of types of computing devices, such as desktop computers 1 and 2, laptop computer 2, tablet computers 3 and 4, and smartphones 5 and 6. Devices 1-6 can be any of a variety of conventional and commercially available devices, including for example, desktop and/or laptop computers available from Lenovo, Dell, Acer, Apple, and the like, tablets available from Microsoft (including Surface tablets), Apple (including iPad and iPad mini tablets), Samsung, and the like, and phones available from Nokia, Apple (including iPhones), Samsung (including Galaxy phones), and the like. In addition, any of the devices 1-6 can comprise connected devices, such as a Microsoft Xbox, FireTV, Sony PlayStation, Nintendo Wii, Roku, AppleTV, Google Chromecast, and the like. Those skilled in the art will appreciate that the devices 1-6 may be the same, or a mix of such a variety of devices from various manufacturers, and that the mix may include devices 1-6 with a variety of different processors, operating systems, and software applications running on such operating systems.

As shown in FIG. 1, users can use their respective devices 1-6 to connect to a network 10 at any given time. For purposes of illustration, the network 10 will be usually referred to herein as the Internet. Those skilled in the art will appreciate, however, that the network 10 can be a cellular telephone network, the land-line PSTN, a private local or wide area network, a Wi-Fi network, or can be some combination of some or all of the foregoing types of networks. Although lines are used in FIG. 1 to show a connection between the devices 1-6 and the network 10, those skilled in the art will appreciate that the connections can be made wirelessly, such as wirelessly to a Wi-Fi and/or cellular communication network, and for example, to the Internet via a Wi-Fi or cellular connection.

Still referring to FIG. 1, a computer server 20 is also connected to the network 10. The server 20 can be any one of a variety of types of computers commercially available from a variety of manufacturers. Server 20 can include an operating system, one or more processors, random access memory, and other conventional items of conventional servers. Although shown in FIG. 1 as a single computer, server 20 can be one or more distinct computers configured to handle the receipt and handling of requests for information from a number of devices, such as devices 1-6, such as by providing a rack of servers as server 20. Also shown in FIG. 1 are a database 25 and a video database 30. In this particular embodiment illustrated in FIG. 1, the database 25 can include user and account information corresponding to a number of users, as well as html information useful to provide to users, such as for formatting and displaying the information provided by server 20 via the network 10 to devices 1-6 in response to requests for information from devices 1-6. The video database 30 in this embodiment can store a variety of videos in a variety of formats, as well as related information, such as, for example, tags to associated videos, lists of videos, images for the videos, and the like. The videos can include but need not be audiovisual files in this embodiment. In addition, the videos stored in the video database 30 can be of a variety of lengths, such as from seconds, to minutes, to hours, and can be of a variety of different subjects, as described in more detail below. As noted, the video database 30 in this particular embodiment can also include information associated with each of the videos stored in the video database 30, such as tags or files indicating the subject(s) to which each of the videos relates, such as those described in more detail below. Those skilled in the art will appreciate that, although the database 25 and video database 30 are shown as separate databases, they can be combined if desired, or can be further separated into still more databases if desired, such as, for example, a separate database for html information. Those skilled in the art will also appreciate that the database 25 and video database 30 may be stored in any one of a number of types of non-volatile storage as may be desired, such as hard drives or disks, DVDs, CDs, external drives, and the like, and may be connected to the server 20 directly or indirectly, such as by a wire, fiber optic, or bus connection or wirelessly, and via a network if desired.

The server 20 has software 22 installed and running on it which is configured and operable to receive and respond to requests for information received via the network 10 from devices 1-6. Devices 1-6 may send requests for information to the server 20 in a number of ways. First, some or all of devices 1-6 may have Internet browsing software and one or more application software programs configured to send requests for information to server 20 in response to a command or request from the user to device 1-6. For purposes of simplicity, the following illustrative example focuses on the case in which a user uses Internet browsing software on one or more of devices 1-6 to request information from server 20. However, those skilled in the art will appreciate that the computing devices 1-6 may have software applications installed and running thereon, with such applications operable to connect to the server 20 via the network 10 and transmit information to and receive information from the server 20, display the video files, and otherwise allow the user to access and interact with the information in database 25 and video database 30 as described below. Moreover, it will be appreciated that some or all of the user information described in the examples below can be stored on the computing devices 1-6 as may be desired.

Also shown in FIG. 1 are computing devices 50, 51 and 52. As with devices 1-6, devices 50-52 can be any one of a variety of types of conventional computing devices. As shown in FIG. 1, devices 51 and 52 are connected to both the network 10 and to device 52. Device 52, however, is shown as connected directly to server 20 as well as to devices 51 and 52, but not via network 10. In this particular example, device 50 may be a computer operated by the National Football League (NFL) or one of its affiliates. Devices 51 and 52 may be computers operated by specific teams that are members of the NFL; in the example shown in FIG. 1, device 51 is a computer operated by the Houston Texans and device 52 is a computer operated by the Green Bay Packers. For simplicity, only three devices 50-52 are shown with respect to the NFL and two of its teams; those skilled in the art will appreciate that in practice more than two NFL teams may have computers connected to the network 10 and/or to one or more NFL computers 50. Similarly, those skilled in the art will appreciate that the NFL may have more than one computer 50 connected to the server 20 and/or to team computers 51 and 52. In addition, any of devices 50-52 can be connected to the network 10 if desired, or directly to server 20 if desired. For purposes of illustration, however, FIG. 1 shows that the devices 50-52 may be connected directly or indirectly to one another and/or to server 20 as may be desired.

In this embodiment, operators may use the computers 50-52 to transmit video files and related information to server 20 to be stored in database 25 and/or video database 30. For example, the NFL computer 50 may be used to transmit video files created or obtained by the NFL to the server 20 and to video database 30, such as, for example, archive footage from past movies, shows, and games, pre-game shows and analyses, shows regarding the NFL Draft, Combine, Pro-Bowl, Super Bowl, and/or other NFL events, news shows, commentary, and the like, as well as live game broadcasts, highlights from past and ongoing games, and the like. In addition, server 20 may transmit requests for and obtain information from the NFL computer 50. For example, if the NFL computer 50 has access to fantasy football league and user information, such information may be useful and used by server 20 as described below. Similarly, the server 20 may request information from the NFL computer 50 such as video files, programming guides, schedules, and a wide variety of information that may be useful and used as described below. In this example, the team computers 51 and 52 may be used to provide team-specific video files and information to the server 20, such as via the NFL computer 50 or via the network 10. It is anticipated that the team computers 51 and 52 (and the NFL computer 50, for that matter) may be located at geographically distinct locations potentially hundreds or even thousands of miles away from the location of server 20. However, it is also possible that the team computers 51 and 52 could be directly connected to the server 20 if so desired. The team-specific information and video files to be provided via the computers 51 and 52 could be any one of a variety of types, including video of summer camp, team meetings, public or private events involving team members or representatives, pre-game warm-ups or meetings, halftime talks, and post-game events, among others. Those skilled in the art will appreciate that although FIG. 1 shows the computers 50-52 as each being a single computer, computers 50-52 illustrated in FIG. 1 may be any number of computers or even computer networks maintained by the relevant teams and/or NFL.

In this embodiment, the software 22 installed and running on server 20 has one or more programs which have instructions for requesting and responding to requests for information that may be received from computers 50-52. The software 22, for example, is programmed to allow the computers 50-52 to be used to upload or transmit video files and related information regarding the files to the server 20 and video database 30. The software 22 is programmed to manage the handling and storage of such video files and related information in the video database 30.

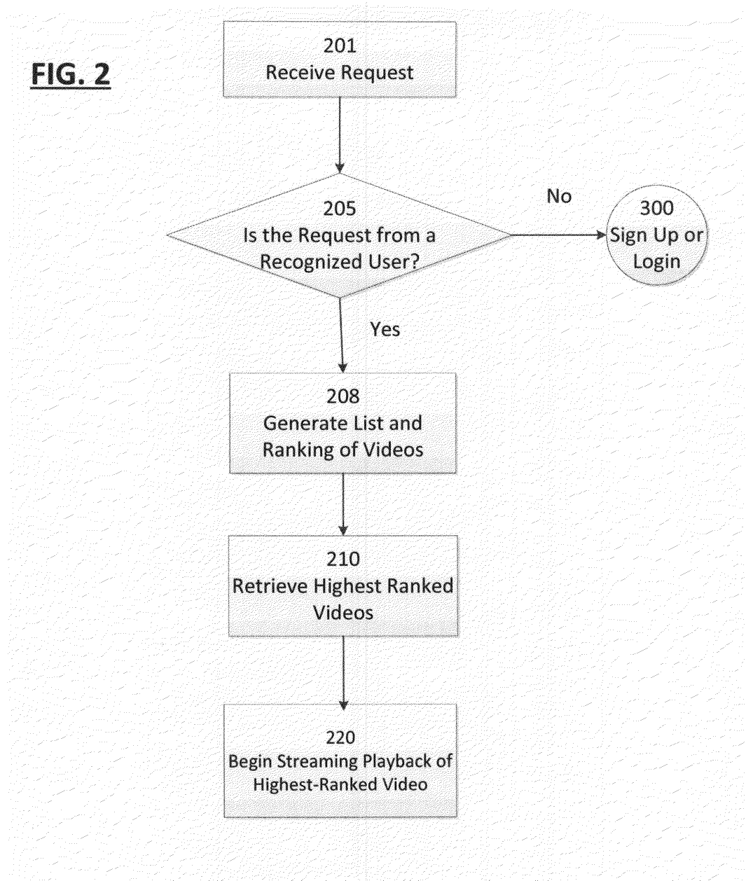

Referring now to FIG. 2, a flow chart is provided which illustrates the steps that the server 20 can take in response to a request received from one of devices 1-6 in accordance with the instructions in the software 22. The server 20 first receives the request at step 201. At step 205, the server 20 checks the information received from one of the devices 1-6 to see if it corresponds to user information already stored in database 25. If the information received matches user information stored in database 25, then the server 20 proceeds to step 208. If not, the server 20 proceeds to step 300 and proceeds through a sign up or login procedure. At step 208, the server 20 generates a listing of the highest-ranked videos for the user who sent the request for information. At step 210, the server 20 retrieves the relevant and desired information for the list of highest ranked videos from video database 30, and at step 220, the server 20 sends information to the user, with the information including information to generate a webpage or display on the relevant one of the devices 1-6 which sent the request, with the page or display including a streaming display of the highest-ranked video file and further information regarding one or more additional videos for that user, such as a list and/or screen image(s) of the second- and third-highest ranked videos for that user. Once this information has been sent by the server 20, the server 20 waits for the next request, which may be from the same or a different user.

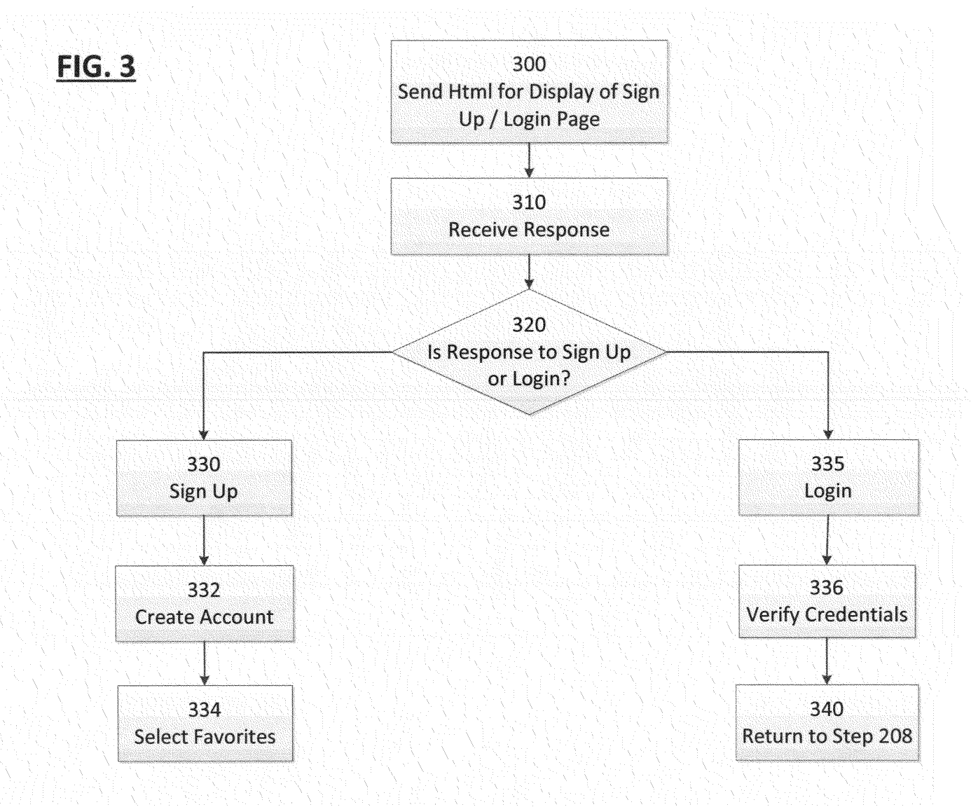

Referring now to FIG. 3, additional aspects of the operation of the server 20 in accordance with the instructions in the software 22 in this particular embodiment are illustrated. At step 300 in FIG. 3, the server 20 sends the relevant information to the one of the devices 1-6 that requested information but was identified by server 20 as not being from a recognized user. The information sent at step 300 can be, for example, relevant html information to generate a “Sign Up or Login” page to be displayed in a browser pane on the one of the devices 1-6. Such a page can be used to prompt the user to enter the relevant information into the one of the devices 1-6 and send it to server 20. In the example shown in FIG. 3, the Sign Up or Login page first asks the user to respond by indicating whether the user wishes to sign up for the service or wishes to login to an existing account. Depending on the response received from the user's device in response to step 320, the server 20 may take alternative approaches. As shown in FIG. 3, the server 20 in response to a Sign Up request in response to step 320 will proceed to step 330 and provide one or more sets of information to the user's device to display one or more pages in the user's browser to prompt the user to provide and transmit the information deemed relevant to create a user account. Such information can include name, address, telephone number, email address, credit card information, and such demographic and socio-economic data as may deemed appropriate (e.g., income level, age, gender, marital status, hobbies, place of employment or profession, and the like). Those skilled in the art will appreciate that more or less information can be requested and/or required, and can be requested and/or required for some but not all users of a service, as may be desired. The server 20 receives such information from the user's device and stores the same in database 25. In this embodiment, the server 20 creates an account for the user with the account information including some or all of the information provided. Once the required information has been provided and a user account created, the server 20 in this embodiment then moves to step 334, which begins the process of allowing a user to select a favorite team, player and otherwise provide information that server 20 can use to personalize the videos to be provided to the user based on the user's expressed preferences.

Still referring to FIG. 3, if the response from the user to step 320 is the selection of the login process (e.g., the user indicates that the user has already created an account), then server 20 proceeds to step 335. At step 335, the server 20 sends relevant information to the user's device to allow the device's browser to display a login page, such as a page requesting a user name and a password. Those skilled in the art will appreciate that the login page can require more or less information, and that the password can be required to have more than merely minimal complexity (e.g., the password can be required to have both numbers and letters, at least one capital letter, and at least one special character, such as “StormLake2000alum!”). Once the server 20 receives the username and password information requested, the server 20 proceeds to step 336 to check the received information against the information stored in database 25 to verify that the information received is correct for an existing user account. Once the user is verified as an existing user (and in good standing, or a subscriber of premium service, if desired), the server 20 next proceeds to step 340, wherein the server 20 returns to step 208 as described above.

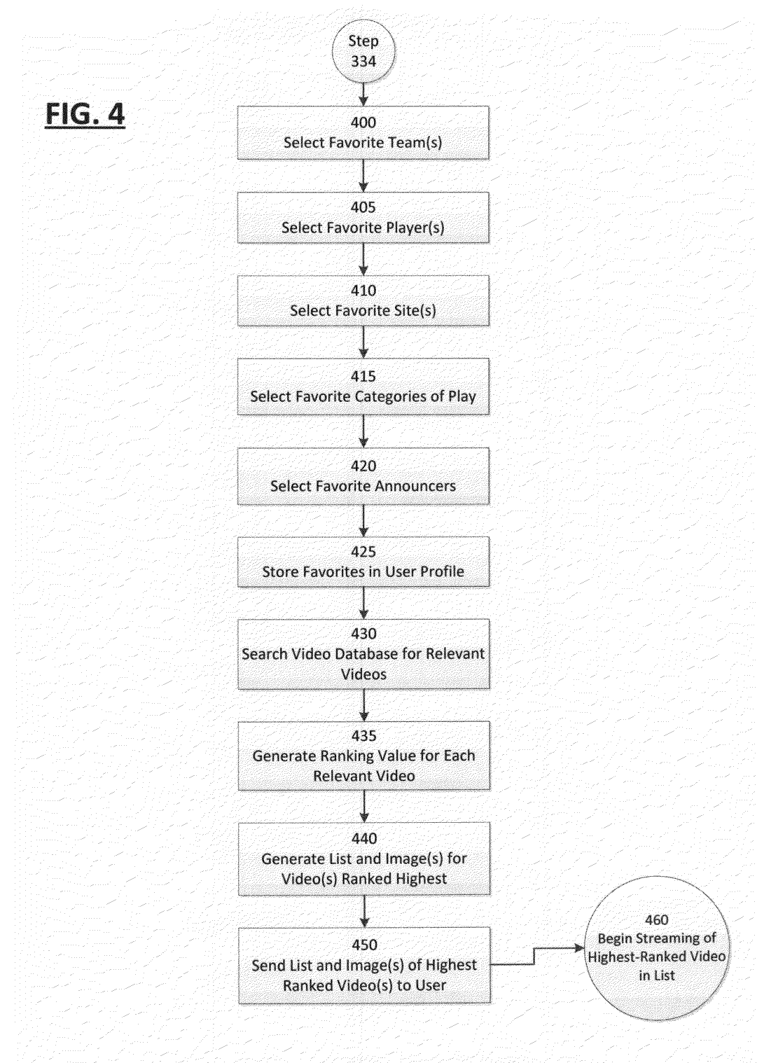

Referring now to FIG. 4, a flow diagram is provided to illustrate the process by which the server 20 in accordance with the instructions in the software 22 obtains information from a user regarding user preferences and provides a list of videos to the user that are personalized for the user. In this particular embodiment, the process is shown starting with step 334, but the process discussed and illustrated in FIG. 4 can occur earlier or later than the step 334. As indicated in step 400, the user is prompted to select one of more favorite teams. Next, the user may be prompted to select one or more favorite players at step 405, one or more favorite sites or stadiums at step 410, one or more categories of play (e.g., passes, runs, blitzes, kickoff returns, sacks, interceptions, fumbles, penalties, blocked kicks or punts, and the like) at step 415, and one or more favorite announcers, narrators, or commentators at step 420. Those skilled in the art will appreciate that more or less than these selections can be made, these selections can be made in any order, and the server 20 can be programmed to prompt the user to select still other favorites in addition to or in lieu of some or all of those illustrated in FIG. 4. For example, a user may be allowed to select one or more favorite coaches, league personnel (e.g., the NFL Commissioner, the Houston Texans owner, and so forth) and the like. Moreover, server 20 can be programmed so that the user may choose to skip selecting a favorite at one or more of steps 400, 405, 410, 415, and 420, or alternatively may indicate that the user has no particular preference at any of such steps (e.g., at step 420, the user may indicate that the user has no particular preference for any given announcer). The server 20 can provide these prompts to the user device by displaying a page which includes a drop-down menu, allows the user to type in the user's preference, displays icons or other images of the selections available and allows the user to indicate a preference by clicking on the same, or in other ways that those skilled in the art will know. Although indicated as distinct steps in FIG. 4, those skilled in the art will also appreciate that the server 20 can provide the user device with information to generate a display on the device (such as on one or more pages in a browser window on the device, for example) which simultaneously lists more than one of the categories of information for which a user preference is requested, including those discussed in connection with steps 400, 405, 410, 415, and 420. Those skilled in the art will appreciate that, for purposes of simplicity and brevity, the examples provided in this disclosure focus on professional football, but the systems and methods disclosed herein can be used in connection with video information relating to other sports, such as basketball, baseball, hockey, car racing, and the like, and can be used with non-sports related video information, such as concerts, musical groups and performers, entertainers, and all sorts of events that people enjoy watching. The user's preferences can be stored in non-volatile memory in database 25 and can be accessed and used by server 20 according to the instructions of software 22.

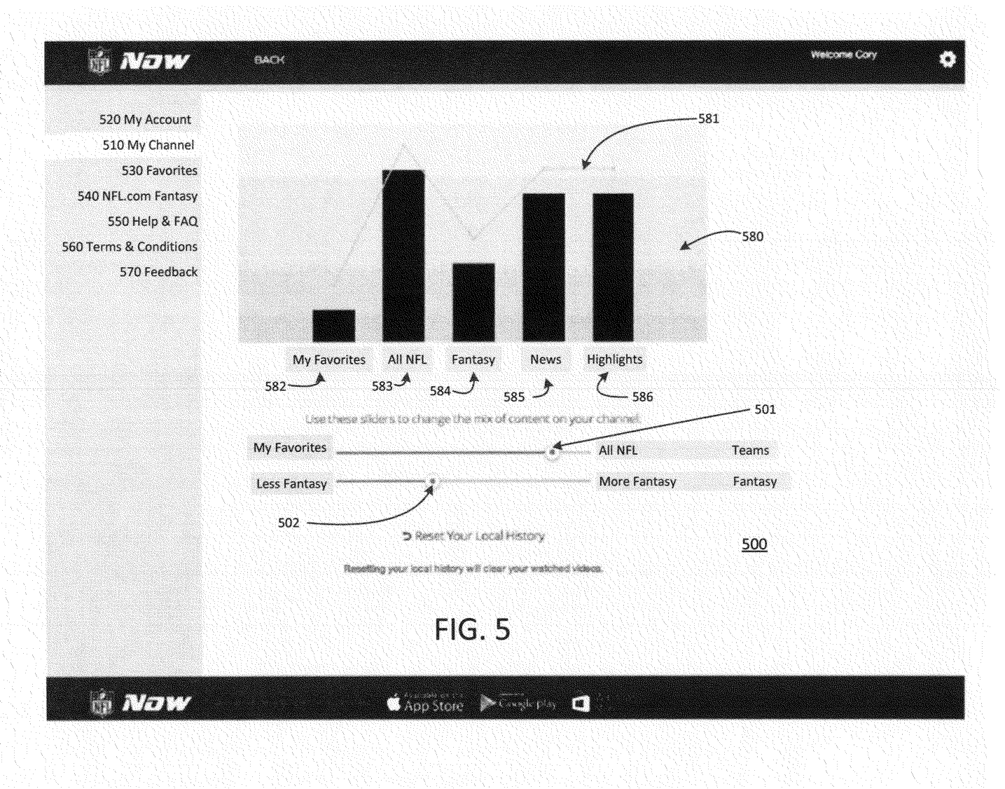

In addition to or in lieu of the foregoing process for allowing a user to indicate the user's preferences, the following approach can be used. In one embodiment, the default screen displayed to a user who is recognized as a returning user, or to a new user who has just registered, can be a particular screen “channel” from one of a potential number of “channel” screens, which may also include, for example, a highlights channel, a classic games channel, a gameday channel, and the like. The default screen can be a “My Channel” screen display to provide the personalized information for that particular user in accordance with the user's user profile information, or the My Channel screen can be accessed by a user by clicking on a button labeled as “Settings,” “Tools,” or the like, or an icon to indicate that it allows the user to access the user's profile, account, settings, preferences, tools, or the like. The My Channel screen 500 can include a series of slider bars 501 and 502 such as illustrated in FIG. 5. As shown in FIG. 5, the slider bars 501 and 502 correspond to slider bars labeled “Teams” and “Fantasy”. By moving the slider bars 501 and 502, the user can express a preference for the relative weight to be given to the user's preferences. For example, by moving slider bar 501 towards the end of slider bar 501 labeled “All NFL,” the user indicates a lower preference for video files for his particular favorite teams than if the user moves the slider bar 501 towards the other end of slider bar 501 marked “My Favorites.” By moving the slider bar 501 all the way to the end marked “My Favorites,” the user can express a much stronger relative preference for essentially only those video files which relate to one or more of the teams the user has indicated are a favorite of the user. Similarly, by moving the slider bar 502, the user can express a preference for greater emphasis on the user's fantasy football teams and players, and video files relating to fantasy football. In one embodiment, the user is provided with the slider bars 501 and 502 each and every time the My Channel screen 500 is displayed, thereby allowing the user the opportunity to adjust the user's preferences and allowing the user to do so during each session in which the user is connected to the computer server 20. In this embodiment, the default settings for each of the slider bars 501 and 502 can be in the middle, thus indicating a neutral relative weighting with respect to the user's relative preferences as to emphasis to be given to the user's team selection, fantasy football, and highlight videos.

A visualization data field 580 is included in the My Channel screen 500 shown in FIG. 5. The field 580 includes a series of bars to form a bar chart, with the bars corresponding to different categories of information. As shown in FIG. 5, the categories include the following categories: 582 for “My Favorites,” 583 for “All NFL,” 584 for “Fantasy,” 585 for “News,” and 586 for “Highlights.” In addition to the bar chart formed by the bars corresponding to categories 582-586, the data field 580 also includes a line 581 which graphically shows the relative emphasis on the categories 582-586. Thus, the field 580 provides two ways to visually depict the relative emphasis on the categories 582-586. As a user moves the slider bars 501 and 502, the movement of the slider bars 501 and 502 will be sent to the server 20 from the user's device. In response to the information provided to the server 20, the server 20 in accordance with software 22 send information to the user's device to adjust the display in field 580 to reflect the user's movement of the slider bar 501 and 502 settings. As the user makes such adjustments to the slider bars 501 and 502, the display on the user's device of the line 581 and the relative heights of the bars corresponding to categories 582-586 shown in field 580 will be adjusted to reflect the change in relative emphasis of the categories 582-586 that the user's movement of the slider bars 501 and 502 reflects. As shown in FIG. 5, the setting on slider bar 501 is located much closer to the “All NFL” label than the “My Favorites” label at the other end. In addition, the setting on slider bar 502 is located just over halfway and towards the “Less Fantasy” label instead of the “More Fantasy” label. As a consequence of the locations of the slider bars 501 and 502 set by the user, the relative mix of videos to be provided by the server 20 to the user is depicted by the relative heights of the bars corresponding to the categories 582-586 in data field 580, as well as the line 581 over the category labels for categories 582-586. By adjusting the slider bars 501 and 502, the user can visually see the effects of the movement of the slider bars 501 and 502 on the relative mix of videos by category. Those skilled in the art will appreciate that more or less slider bars than bars 501 and 502 may be used, and that additional slider bars may be used to indicate still other user preferences, such as the length or running time of video files. For example, a user might prefer shorter videos, such as those of two minute, for example, in length or shorter, over longer videos. Those skilled in the art will appreciate that the use of such preferences for shorter or longer videos may be useful for users with more expensive, slower, or less reliable connections to the network 10 and server 20. Similarly, those skilled in the art will appreciate that the slider bars 501 and 502 (or other or additional slider bars if desired) can be used to provide a greater or lesser emphasis on different subject matter than reflected in categories 582-586 in field 580, as may be desired.

In another embodiment, the My Channel screen 500 may include a series of icons (not shown) labeled by the tags or identifiers used and associated with the various video files. For example, such tags may include team name, player name, coach name, type of play, type of game, and any one of a variety of types of information about some or all of the video files available in the video database, including the tags listed below. In this embodiment, the user is allowed the opportunity to select all or some of the tags to indicate the user's preferences for video files. The use of such tags to indicate user preferences may be in addition to or in lieu of the approaches indicated above to allow a user to indicate preferences.

The My Channel screen 500 display may also include an icon allowing the user to reset the user preferences. For example, an icon of a button or the like may be provided that is labeled “Reset Preferences” or the like. If the user presses this button, the system may provide a dialog box on the display asking the user to confirm that the user wishes to reset the user's preferences to default settings and does not wish to have the prior preferences stored. In such a situation, the user's confirmation of a reset will result in the deletion of the previously indicated user preferences and restoration of default settings (such as having the slider bars placed at the middle position with the resulting weights given to such information). In this embodiment, a user may be allowed to reset the preferences associated with the slider bars 501 and 502, for example, yet retain the user preferences provided otherwise, such as the selection and input of team and user favorites. It will be understood that each time a user adds to or otherwise modifies his or her preferences, the user's profile in database 25 is updated by server 20 so that the additional and/or modified preferences are stored in non-volatile memory.

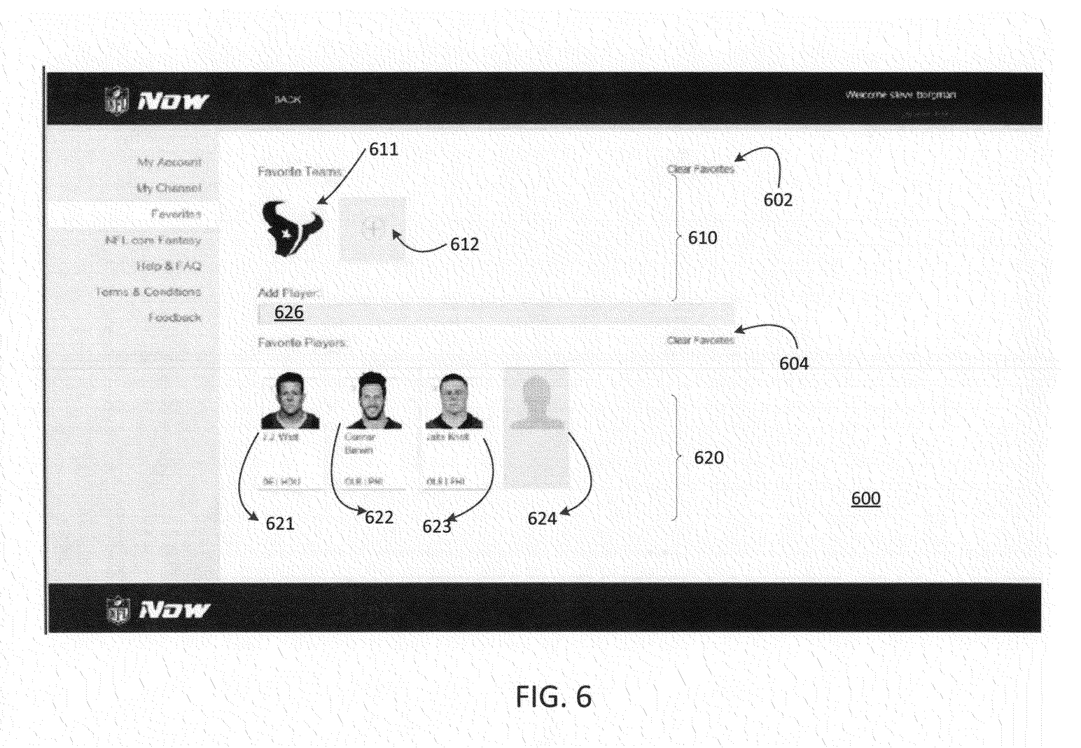

As shown in FIG. 5, the My Channel screen display 500 has the “My Channel” field 510 highlighted. This indicates that the user has navigated to the My Channel screen display 500. The My Channel screen display 500 as shown in FIG. 5 also includes fields 520, 530, 540, 550, 560, and 570, which can be clicked on by the user to navigate away from the My Channel display 500. Clicking on the My Account field 520 will take the user to a display showing the user's account information and allowing the user to edit the same. Clicking on the “Favorites” field 530 will take the user to a display showing the user's previous selections as to favorite teams and/or players, such as shown in FIG. 6 for example. Clicking on the “NFL.com Fantasy” field 540 could take the user to a website for fantasy football. Clicking on the “Help and FAQ” field 550 will take the user to a screen display with the answers to frequently asked questions and information designed to help the user, as well as to allow the user to contact support personnel or submit questions to be answered by support personnel. Clicking on the “Terms and Conditions” field 560 will take the user to a screen display of the terms and conditions applicable to the use of the service. Clicking on the “Feedback” field 570 will allow the user to submit feedback, such as via email, instant messaging, text message, directly via the user's device, or otherwise. Towards the top left of the My Channel display 500 is a “Back” button. If the user clicks on this button, the user will be taken back to the screen from which the user navigated to the My Channel screen.

Referring back to FIG. 4, once the user has made the requested selections indicating the user's preferences, the server 20 in accordance with the instructions of the software 22 stores the user's preferences in database 25 at step 425. These can be stored in the user account profile or in another file associated with the user, as may be desired. Once the server 20 has obtained one or more preferences from the user, the server 20 can then search the video database 30 for video files that are relevant to the user's expressed preferences at step 430. For example, if the user has indicated that he or she likes the Houston Texans best and has selected them as a favorite, the server 20 can search the video database 30 for video files that are associated with the Texans. Similarly, if the user has indicated a preference for both the Texans and, for example, a particular player, the server 20 will search the video database 30 for video files that are associated with both the Texans and that particular player.

Referring now to FIG. 6, an example of a “Favorites” screen display 600 is provided. The Favorites screen display 600 includes a team favorites field 610 and also a player favorites field 620. As shown in FIG. 6, this user has indicated that the Houston Texans are the user's only favorite team, while the user has indicated that J. J. Watt (in player field 621), Connor Barwin (in player field 622), and Jake Knott (in player field 623) are player favorites previously selected by this user. As shown in FIG. 6, a blank team field 612 is provided. By clicking on blank team field 612, the user can add an additional team as a favorite. Similarly, a blank player field 624 is provided. By clicking on the blank player field 624, the user can add another player as a favorite. The Favorites screen display 600 also includes two “Clear Favorites” buttons 602 and 604. Each is located in a manner relative to the team favorites field 610 (in the case of button 602) and the player favorites field 620 (in the case of button 604), thereby indicating that clicking on button 602 will clear the selections of team favorites previously made by the user, and clicking on button 604 will clear the selections of player favorites previously made by the user.

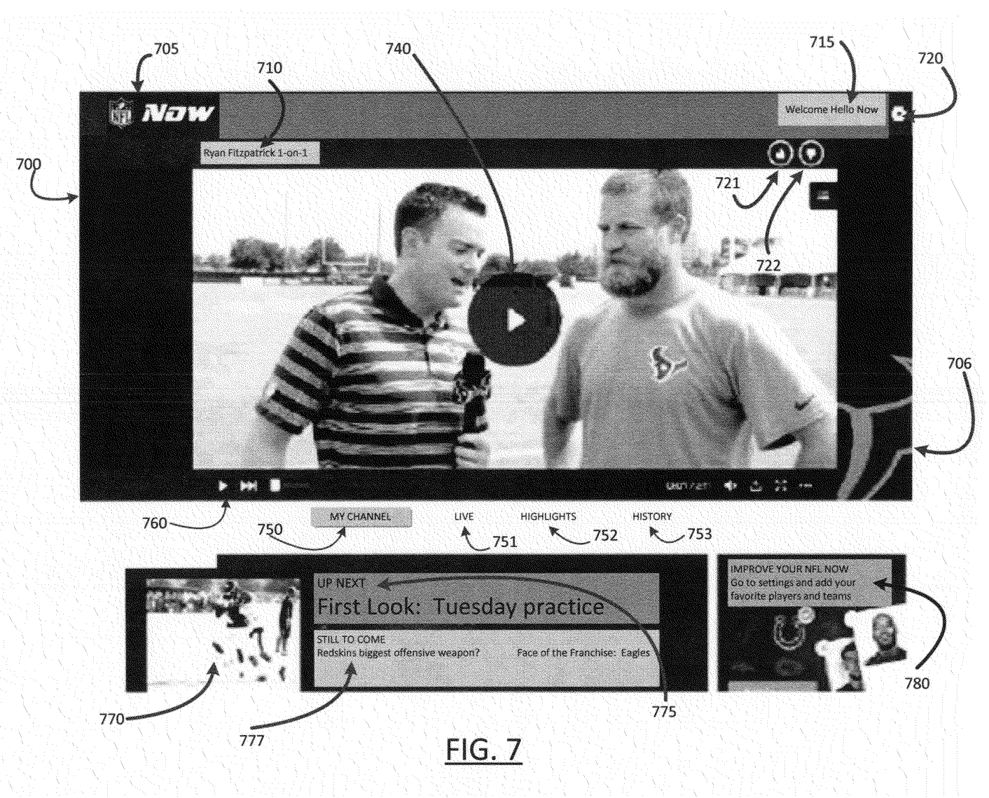

Referring now to FIG. 7, an illustrative screen display is provided. In FIG. 7, an example screen is shown that might be sent to a user who logs into or connects with server 20 via one of devices 1-6 (show in in FIG. 1, not FIG. 7). The display shown in FIG. 7 thus represents the information the server 20 sends to be displayed on the user's device. As shown in FIG. 7, a first panel 700 is displayed on a user device's screen. The first panel 700 may include a league icon 705, and may be an active link so that when a user clicks on it, the user is taken to a home page (such as NFL Now's home page). Similarly, other icons may be shown, such as a logo 706 to indicate a particular team from which the video file was provided or to which the video file relates. In addition, a data field 710 can be provided which provides the title of the video file being displayed in first panel 700 (such as “Ryan Fitzpatrick 1-on-1”). A play icon 740 is shown in the first panel 700; by clicking on the play icon 740, the user can start the video playing in the first panel 700. The first panel 700 also includes like and dislike icons 721 and 722, respectively. The user can indicate his or her preferences by clicking on icons 721 and 722 such as in the manner described herein. The first panel 700 also includes icons 715 as a welcome statement, and a tool icon 720. When the user clicks on the tool icon 720, the user can then be provided with a screen which allows the user to set his or her preferences as described herein, such as by adding or deleting team and player preferences and the like. The first panel 700 also includes a video control toolbar 760. This toolbar 760 includes icons which allow the user to initiate the playing of the video file, skip ahead or fast forward the video file, adjust the sound volume for the sound associated with the video file, and share the video file on social media or other websites, such as FaceBook, Twitter, Instagram, and the like.

As also shown in FIG. 7, just below first panel 700 are several button icons 750, 751, 752, and 753, respectively labeled “My Channel,” “Live,” “Highlights,” and “History.” As indicated by the different color associated with the My Channel button 750, the screen display in FIG. 7 is a display of a portion of the My Channel screen. By clicking on any of button icons 750-753, the user can navigate to or from various types of video files with respective subject matter indicated by the button icons 750-753. For example, by clicking on the “Live” button icon 751, the user can navigate to the Live channel from the My Channel display, and can watch live video of an event, such as a press conference or interview of a coach or player or other team or league personnel (e.g., owners or the NFL Commissioner), or game in progress, or see a listing of ongoing games and the scores associated with the ongoing games. Similarly, by clicking on the “Highlights” icon 752, the user can navigate to a separate page on which the user can see video highlights of one or more games that are ongoing or occurred earlier. The videos to be provided and streamed to a user on the Live and Highlights channels may, but need not, be personalized for a user as described herein for the My Channel display.

Still referring to FIG. 7, a second panel 770 and a third panel 780 are shown. The second panel 770 may include a photo or image, which may be a screen capture from the next video file in the ranking after the one displayed in panel 700. As shown in FIG. 7, the second panel 770 has a data field 775 listing the title of the next video file (e.g., “First Look: Tuesday practice”) after and below the heading “Up Next.” Below this video title, the second panel 770 may include another heading and data field 777 (e.g., “Still to Come”) under which additional video file titles may be listed. In this particular embodiment, the video file and titles shown in panel 700 and 770, respectively, are the video files ranked in order of user's preferences as determined by the total points for such video files as described herein. Finally, the third panel 780 shown in the display presented to a user in the particular embodiment shown in FIG. 7 encourages the user to consider clicking on it to navigate to a screen (such as the one shown in FIG. 6) which allows the user to set his or her preferences as described herein.

Those skilled in the art will appreciate that the icons shown in FIG. 7 may vary considerably in shape and appearance, as well as in placement. For example, a thumbs up and thumbs down pair of icons for the like and dislike functions need not be used, but other icons might be used in their place (e.g., happy and sad faces, respectively or the like). Similarly, the size and placement of the various data fields and panels shown in FIG. 7 may be adjusted as desired. More specifically, the software 22 on server 20 may adjust the information sent to a user device with respect to the layout of the display and/or the information provided in the user device's display (e.g., the number of titles of video files, if any, included in a second panel 770 if provided) depending on the particular device the user is currently using. For example, if the user is using a device with an iOS operating system, the server 20 may send only the first panel 700 instead of the combination of panels 700, 770 and 780. In addition, or alternatively, the server 20 may send information corresponding to a different layout of panel 700 if the current user device is using an iOS operating system than if the user device is using a Windows operating system. This is yet another manner in which the present disclosure provides flexibility in personalizing the information provided to a user.

The server 20 (shown in FIG. 1) can also be programmed with software 22 to obtain information relevant to a user from other sources than what the user expressly provides in response to prompts like the foregoing. For example, if the user is also a user of a website service for fantasy football, for example, and that information is available to the server 20, the server 20 can use such information. For example, suppose a given user also participates in one or more online fantasy football leagues, including one or more fantasy football leagues such as those available to users via the NFL.com website or another website which is hosted by or to which NFL computer 50 (shown in FIG. 1) is connected. In such an event, the server 20 may obtain or be provided information from computer 50 as to the user's fantasy football league information and that information may be made available to the server 20. In such a case, the server 20 may be able to obtain additional information about the user from the user's fantasy football league profile(s). For example, such profiles may indicate place of employment or other information about user that is not requested or otherwise obtained by server 20. Moreover, a user's place of employment may be deduced if, for example, all players in a fantasy football league have the same employer. Similarly, the user's selection of players for the fantasy football teams may indicate that the user has an interest in players or teams that the user did not indicate were favorites or otherwise express interest in during the sign up process. Another example might be if the user is an alumnus of a particular college or university; in that case, the user may be interested in players who played for that college or university. As described below, the server 20 can also maintain a log of information regarding the user's viewing history, such as a log of video files reviewed through to completion, a list of videos suggested, but not watched by the user, a list of videos suggested and only watched partially, then skipped, a list of videos watched more than once, and the like. In addition, the server 20 may include such information relevant to users from other users who share relevant information in their user profiles, such as for example, a list of video files watched more than once by a number of users who share a common team preference as a favorite team. As described below, such information can be used to rank video files of potential interest to a user.

Referring now to FIG. 4, at step 435, the server 20 in accordance with the instructions of software 22 generates a ranking value for each relevant video found during the search or searches performed as part of step 430. The manner in which the ranking value may be determined is described in more detail below. Once the ranking value has been determined for one or more video files relevant to the user's preferences at step 435, the server 20 then may move to step 440 and generate a list of the relevant video files, together with images (such as screen captures from the video file, for example), with the list ordered based on the relative ranking values determined for each of the video files included in the list. At step 450, the server 20 sends this list and image information to the user's device for display, and at step 460 begins streaming the highest-ranked video on the display of the user's device. The user can select one of the other videos for viewing (such as by clicking on its title or image as displayed on the user device display) and send a request to receive the same to the server 20. In response to such a request, the server 20 can retrieve the selected video file from video database 30 and send it to the user's device, thus providing the user with the selected video. In this embodiment, each video file is streamed over the network 10 to the user's device, where it is displayed on a screen on the user's device. Those skilled in the art will appreciate that the server 20 can also allow the user to request a download of the video file and provide the video file as a download.

In one particular embodiment, the highest-ranked video can automatically begin streaming to the user's device and be displayed on such device. The user can then choose to watch the highest-ranked video in full or in part, or to skip the video such as by clicking on a skip icon on the display on the user's device, or by clicking on the title of another video displayed on the user's screen or the image for another video displayed on the user's screen. Such action by the user will be sent by the user's device to server 20. If the user simply performs an action interpreted as a skip command, then the server 20 will either begin streaming the second-highest ranked video on the list, or the server 20 can perform another search of the first thousand group of videos (which may have been updated since the user began watching the highest-ranked video in the initial list) and generate another ranking of videos and then provide updated video information to the user based on the second ranking (e.g., begin streaming the highest-ranked video in the second list and provide the titles and/or screen image(s) for additional videos in the list). The server 20 may be programmed to perform such additional searches and rankings for each user on a scheduled basis (e.g., every two minutes while the user is connected to or logged into the server 20), on a basis such as directed by the user (e.g., the user clicks an icon titled “Generate a New List of Videos” or the like), or on a combination of some user action or inaction, timing, and the remaining time status for a video currently being streamed to the user's device.

The server 20 can be programmed with a personalization engine program (which in FIG. 1 is illustrated as part of software 22) to generate a ranking of potentially relevant videos based on information related to a number of videos stored in the video database 30, and a variety of user preference data, as well as information regarding the user's viewing of videos, searching of videos, and comments on videos, among other things. All of the user information (including user preferences, user viewing history, user likes/dislikes and other user actions) can be stored in the database 25 in non-volatile memory. In addition, information about each video file and its subject matter may be used. Among other things, the recency of the video content itself may be important, since the user's interest in certain video content is likely to decay at a greater or lesser rate for certain types of video files than others. The server 20 can be programmed with software 22 to provide a personalization engine to assess a ranking value, score, or weighting using a variety of different algorithms and factors, such as by weighting some user preferences higher than others, for example. In addition, the weights and values assigned to various factors for ranking the video files, and thus the resulting rankings of video files for each user, can vary depending on the time of day, day of the week, season, and coincidence with various events. For example, on a typical Sunday during football season, it can be expected that a substantial number of users will want to view videos regarding their team and players and also that day's opposing team and players, as well as analysis of the two teams and their players, and the like. Similarly, it can be expected that a substantial number of users will want to view videos regarding various potential and existing players during the Combine and the Draft of the National Football League. In addition, it can be expected that video files of game highlights may have a different decay rate during the time that that particular game is being played than after the conclusion of the game. Those skilled in the art will appreciate that the system and methods of the present disclosure provide a great deal of flexibility in assigning values to various factors associated with each video file and with the values to be assigned at any given time and for any given user. The following specific description of the manner in which a ranking value can be determined is intended to be understood as illustrative and not limiting.

In one embodiment, a listing of a substantial number of the most recently added video files is maintained by the server 20, such as in database 25 or in video database 30. In this particular embodiment, the video database 30 includes a file which has a list of the 1,000 video files most recently added to the video database 30, based on each video file's publication date and time and, if the video file has been modified or edited, the modify or edit date and time. Typically, the publication date and time would be the date and time that a video file has been made available to users via server 20, not necessarily when a video file has been added to video database 30. This group or first set of a thousand video files and its listing can be updated frequently by the server 20, such as by updating hourly at pre-scheduled times, or by updating the listing whenever a new video file has been added to the video database 30. (As previously noted, such video files may be added to the video database 30 by teams and the NFL, such as via computers 50-52 shown in FIG. 1.) Those skilled in the art will appreciate that more or less than a thousand video files can be maintained in such a listing, such as anywhere between 50 and 50,000, for example, that the listing may be based on information other than publication date and time, or creation or modification date and time (such as, for example, one or more of the data tags or identifiers described below in more detail), and that more than one listing of video files may be maintained and used as described below. We have found that including a thousand video files in this group or set usually provides a great deal of variety of different types of clips which are usually recent enough to likely be of interest to users, and yet is a manageable number for searching, updating, and the like.

In this particular embodiment, when a user logs into the server 20 or connects via an application on a phone or other device, and is recognized by the server 20, the personalization engine portion of the software 22 running on server 20 automatically searches through the listing of most recent video files, assigns point totals to each of the video files included in the listing, and then returns a list of the most relevant video files for that particular user in order of ranking, with the video file with the highest point total listed first, the video file with the next highest point total listed next, and so on. Depending on the operating system or device platform being used by the user when logging in or connecting to the server 20, the number of video files retrieved and listed for the user may vary. For example, a list of ten video files may be provided and displayed to the user by the server 20 if the user device happens to be a computer, but may include a list of only five video files if the user happens to be using a phone. In this manner, the server 20 (and the personalization software engine portion of the software 22 running on server 20) can personalize the list of video files delivered to the user. Moreover, if the video database 30 is updated constantly as video files and related information are sent to the server 20 (such as via computers 50-52) by the server 20, the group of a thousand most recent video files will be changing and therefore the ranking of the video files of potential interest to a given user may be changing as well.

In this particular embodiment, the server 20 can assess a weighted dynamic score for each video file. In this embodiment, a score or value is determined by adding up an aggregate score of points assigned to various factors associated with each video file. In some cases, the aggregate score may result from the addition of points for some factors and the subtraction of other points for other factors. For some factors, such as team(s) and player(s) associated with a video file, the server 20 assigns a score of, for example, 50 points each for a match between a team associated with a video file and a team associated with a user as a favorite, as well as 50 points for each match between a player associated with a video file and with a user as a favorite.

Similar assignments of points can be made for other matches between the other information associated with a video file and the user's profile. Such point assessments can be the same for each match or can vary depending on the particular match involved. For example, if a user indicates one favorite team, but multiple favorite players which are on different teams in the current season, a greater number of points can be assigned for the match of teams (e.g., 50) and a lesser number of points assigned for each match of players (e.g., 5). In one embodiment, a user may be able to express or indicate the weight that the user places on the various matches and thus affect the weighting system used to personalize the delivery of videos to the user.

Although not displayed to the user, in the particular embodiment shown in FIG. 5, the slider bars 501 and 502 may each have nine distinct segments, so that the location of the slider on each of the slider bars 501 and 502 corresponds to one of nine distinct locations (which may be considered spot 1 on the far left, spot 9 on the far right, with spot 5 in the middle location, and the other spots located respectively). In one embodiment, the slider bars 501 and 502 have a default setting located in the middle or spot 5 position. The server 20 is programmed to receive and store the location of the slider bars 501 and 502 and add or subtract points to the aggregate total score for each video as described below. In this particular embodiment, points are assigned to the locations of the slider bars 501 and 502 as indicated in Table 1.

TABLE 1

| | Slider Bar | Points to be added to |
|---|---|---|
| Slider Bar | Position | aggregate total |
| 501 (My Favorites/All NFL) | Spot 1 | 8 |
| | Spot 2 | 6 |
| | Spot 3 | 4 |
| | Spot 4 | 2 |
| | Spot 5 | 0 |
| | Spot 6 | 5 |
| | Spot 7 | 10 |
| | Spot 8 | 15 |
| | Spot 9 | 20 |
| 502 (Less Fantasy/More Fantasy) | Spot 1 | −4 |
| | Spot 2 | −3 |
| | Spot 3 | −2 |
| | Spot 4 | −1 |
| | Spot 5 | 0 |
| | Spot 6 | 3 |
| | Spot 7 | 5 |
| | Spot 8 | 8 |
| | Spot 9 | 10 |

The points listed in Table 1 may be added to the total points assigned to a video file in order to assist in determining the video file's relative ranking for a given user as compared to the scores of other video files. For example, if the user adjusts the slider bar 501 to the far left position (i.e., the spot 1 position), then an additional eight points is added to the total score for each video file that is associated with that user's favorite team(s). If the slider bar 501 is in the default position (i.e., spot 5 position), however, then no points will be added or subtracted as a result of the location of the slider bar 501. Similarly, the movement of the slider bar 502 to the left of spot 5 will result in the subtraction of points from video files that are associated with fantasy football, but if the slider bar 502 is moved to the right of spot 5, then additional points will be added to the score for each video file that is associated with fantasy football. Those skilled in the art will appreciate that these particular points and specific point assignments can vary or can have more variations than those described in this embodiment, and can be varied depending on other factors, such as, for example, the subject matter of the video, the recency of the video file, or other factors as described herein (such as the tags identified below). For simplicity, however, the foregoing examples do not add additional rules or dependencies to the points to be assigned based on these slider bar 501 and 502 locations.

To account for a user's likely decreasing interest in certain types of video content over time, the weighted dynamic score of a video file can be adjusted, either up or down. In addition, the adjustment for decreasing interest over time (e.g., a decay rate) can vary depending on the type of subject matter of a given video file, as well as the time and date of the publication or creation of the video file, the time and date of the user's request for information or accessing of the service, and the like. For example, different adjustment factors for such a decay rate in likely interest in different types of video files can be assigned as in the following table:

TABLE 2
(Decay Rate Points by Category and Recency, e.g. time from publication)

| Category (Clip Type) | <1 Hour | <3 Hour | <6 Hour | <12 Hour | <24 Hour | <48 Hour | <72 Hour |
|---|---|---|---|---|---|---|---|
| Highlight | 100 | 90 | 60 | 50 | 25 | 15 | 5 |
| Team Sound | 80 | 50 | 30 | 10 | 5 | 5 | 5 |
| Show | 80 | 80 | 80 | 80 | 60 | 30 | 15 |
| Rundown | — | — | — | — | — | — | — |

In this example, the decay rate in the table can be added to the points assigned to a video file based on other factors. The recency of each video clip in this example refers to the time between the video file's publication and the time of the ranking of the video clip by the software executing on server 20. In this specific example, there are four different categories of videos. Publication here refers to the date and time when the video file is indexed and stored in video database 30 and thus available, but could also refer to the date and time first provided to server 20. The “Highlight” category of the present example may include videos from a recent game, or videos from one or more past events in an on-going game or other event, such as the NFL Combine, Draft, or the like. Videos in the “Team Sound” category of the present example may include videos that are team-specific, such as videos of a team meeting, practice, pre-game warm-up, or events in a team's locker room before, during or after a game, such as a pre-game or half-time talk, for example. Such video clips may also include public or private events attended by team members, players, coaches, owners, cheerleaders or other personnel or representatives. The “Show” category of the present example may include videos captured at any show regarding a sporting event, such as a news show or a preview show before or after a game or other event. The “Rundown” category of the present example may include a unique category of video files. In this particular embodiment, for example, the “Rundown” category comprises relatively short video files that are primarily quick summaries of current news, such as a one-minute or two-minute video segment like a “need to know” news summary of recent events. Typically, such segments do not necessarily relate to only one team. It can be seen in Table 2 that no particular points are associated with the Rundown video category or the recency of such video files. In this embodiment, the server 20 and software 22 are designed to present a user with a Rundown video file at the beginning of a user's session when the user logs in or otherwise connects to server 20. This may be done for any number of reasons, such as to ensure that the user is shown a promotional video or banner display from a sponsor or advertiser or because a team or league wants to ensure that certain information is provided to as many people or through as many outlets as possible, for example. Those skilled in the art will appreciate, however, that the Rundown videos could be assigned points as desired and in such case would not necessarily be ranked higher or lower than other videos, depending on a given user's preferences and the content of the Rundown video(s) relative to other videos in other categories.

By assigning points based on a decay rate for different categories of videos, the frequency with which a given video may be presented and/or played can be altered depending on the category of the video. For example, highlight video files less than an hour old can be assigned a score of 100 points due to their recency, indicating a much higher likely interest level than a highlight video file created three days earlier. As indicated by the points listed in Table 2, different types of video files likely have different decay rates at which interest decreases from the time of publication, and points can be assigned to the video files based on their type and the time since their publication to account for and reflect such decreasing interest over time. In some cases, one or more video files may be modified; in such cases, we may base the recency and decay rate weighting on the publication date and time of the modified file instead of the initial publication date and time.

For one specific example of the generation of a dynamic weighted score for a specific video file, consider the following situation. A user who has already established an account and user profile is logged into the server 20 and viewing a video file. This particular user has indicated (and the relevant information is therefore stored in the user's profile) that the San Francisco 49ers are a team favorite, and Vernon Davis is a player favorite. (For this example, it is also determined that this particular user, however, has not used the slider bars 501 and 502 (shown in FIG. 5) to adjust the user's preferences. Moreover, this user has not clicked on a like or dislike button for any prior video.) A new video file is uploaded to the video database 30 and becomes available to the user before the conclusion of the current video file being viewed by the user. This newly available video file includes a highlight of a game between the San Francisco 49ers and the Denver Broncos at Denver, with the specific highlight including a 34-yard touchdown pass by the 49ers' quarterback (e.g., Colin Kapernick) to one of the 49ers' receivers (e.g., Vernon Davis). The weighted dynamic score of the newly added video file in this situation can be calculated as follows: 100 points (the baseline score for a highlight file less than one hour old, as determined by its publication date and time), plus another 50 points (due to the user's prior selection of the San Francisco 49ers as a team favorite), plus another 50 points (due to the user's prior selection of Vernon Davis as a player favorite), for a total aggregate score of 200 points. Because this user has not adjusted any of the slider bars 501 and 502, they remain in the default, neutral position, so no points are added or subtracted to or from the point total for this video file due to such user preference settings. Similarly, because this user has not yet clicked a like or dislike button for a prior video, no points are added or subtracted to or from the aggregate point total due to such user preferences (such as in the manner described below if the user has clicked on one or more like or dislike buttons). The computer server 20 will calculate the aggregate score for this newly added video file and determine based on comparing the aggregate score of the video file relative to the aggregate scores of other relevant video files whether this newly added video file should be added to the user's viewing list and, if so, its ranking, such as whether it should be the next video file presented to the user or should be included as the second-next video file, third-next video file, and so on.

In addition, various points or blanket rules may be adopted with respect to certain video files for potential listing or display for a user. For example, it may be desirable to implement a rule that prevents the suggestion of a video file to a user which the user has either viewed, viewed partially and skipped the remainder, or has skipped entirely in the past, as reflected by a log of such user's activity. At the same time, however, such a rule may have exceptions, such as may be desired if the log of video files viewed by the user demonstrates that the user has viewed one or more video files two or more times, thus indicating that the user does not necessarily mind and may in fact enjoy viewing some video files on multiple occasions. In addition, it may be desirable to prevent the suggestion of display of certain types of video files to a user who is connected with a particular type of device or with a particular type of connection.

A user's viewing behavior may be monitored and used to affect the ranking of video files to be suggested and displayed to the user. When a user is presented with a screen displaying a video file, the display may include icons such as buttons which the user may click to indicate that the user “likes” or “dislikes” the video file being shown. In one embodiment, if the user clicks the “dislike” button, the server 20 can skip the video currently being displayed and move to the next video in the ranking for the user, in addition to logging the user's dislike in the user profile. The user's like and/or dislike icon clicks and skipping of video files can be used to adjust the points allocated to video files for future rankings for that user in a variety of ways. In one particular embodiment, points can be added or subtracted to the points provided for the tags corresponding to a video file which is the subject of one of such actions by a user. For example, if the user clicks the “like” icon, one additional point can be added to the points provided by each tag corresponding to that video file. If the default number of points for a favorite player tag is 20, for example, and the video file involves three players, when the user clicks the “like” button, the server 20 is programmed to adjust the points to be provided in connection with each video file which includes one of the players in the subject video file by adding two points. If the user clicks the “dislike” button, the server 20 is programmed in this example to subtract four points for each tag associated with the video file. If the user merely skips the video file, one point may be subtracted for each tag associated with the video file. In addition, for each video file which is viewed to an extent that it is completed to a given percentage (e.g., viewed to at least 80% of completion), one point can be added for each of the tags associated with the video file. This approach allows the user's actions to influence the points assigned to video files based on their tags in common with the video file which was the subject of the user action, and thus influence the aggregate scores of video files and potentially influence the relative rankings of video files.

In one embodiment, the information associated with each video file stored in the video database 25 can be extensive. For example, the following information can be associated with each video file as a tag or other identifier and stored in the video database 25 as indicated in Table 3.

TABLE 3
Types of Information (Tags/Identifiers) Associated with Videos

| Type of Information | Example/Explanation |
|---|---|
| Recency | When the video file was published and/or modified |
| | (Modified dates takes precedence over publish date) |
| Team Identifier | Teams involved in each distinct video |
| Individual NFL | For all players involved in each distinct video |
| player ID | (Including for Combine, Draft, Training Camp and |
| | Preseason) |
| Active Status | Y or N |
| of Player | |
| Live Event? | Y or N |
| Video Clip Type | E.g., “Show” |
| Video Clip | E.g., “Total Access” |
| Sub-Type | |
| Season | E.g., 2014 |
| Season Type | E.g., Regular Season |
| Week of Season | E.g., Week 8 |
| Duration (TRT) | E.g., 2 minutes, 43 seconds |
| of video file | |
| Source of video file | E.g., NFL.com; NFL Films: Club Content; NFL |
| | Studios Content; or Other/Misc. |
| Video Clip Headline | E.g., “J. J. Watt's Block Against Tom Brady” |
| Video Clip Caption | E.g., “J. J. Watt blocks four passes by Tom Brady in |
| | the first quarter” |
| Channel Affiliation | E.g., NBC, ESPN, Fox Sports, etc. |
| (if any) | |
| Talent/Analysis | E.g., Matt Stafford, Calvin Johnson, etc. |
| Featured | |
| Promotional | E.g., non-ad served video clips (long form trailers, |
| Content | midroll ads for NFL properties like RedZone, etc.) |
| Identifier (if | |
| content is | |
| promotional in | |
| nature) | |

The foregoing disclosure and description has focused primarily on video or audio visual files from a particular type of event. Those skilled in the art will also appreciate, however, that during many events there are also a number of other types of data that can be captured and recorded, and such data can be used as tags or identifiers, or used with other information as tags or identifiers. For example, and staying with the example of a professional sporting event, onfield biometric data from a variety of players and/or coaches and/or officials may be captured and stored, as well as a variety of information that may be obtained from onfield sensors. Similarly, data can be captured and stored as to the GPS (global positioning system) location of players, coaches, and/or officials during a game, as well as the location of the ball or other equipment or items used in the game, at the event location, or otherwise of relevant interest, during (and before and/or after the game). For example, by capturing and storing such information during a given play in an NFL game, a running back's acceleration, path, velocity, and force of impact upon being tackled may be captured and recorded. Such information may prove useful when combined with other information, such as the time of the play during the game (e.g., the first minute of the fourth quarter), the nature of the play (e.g., a slant), the nature of the defense of the given play (e.g., a blitz with five rushers), the results of the play (e.g., a gain of five yards), and the like. For example, it may be helpful to combine the time of game and type of play as tags for video files, together with team and player information. Doing so would allow an interested user to more easily find or have suggested video files showing blocked passes by J. J. Watt in the fourth quarter of Texans games, for example.

Those skilled in the art will appreciate that the server 20 can be programmed with software 22 to monitor and store a variety of information regarding the user's actions with respect to the video files. Such information can include the following in addition to or in lieu of some or all of the user action information mentioned elsewhere herein. For each video file consumed (in any duration) by each user (on any device), the server 20 in one embodiment tracks and stores the following information: platform used for access to server 20 (e.g., desktop, laptop, tablet, etc., and operating system, such as iOS, Windows, Android, etc.); all video metadata tags for video clips begun; duration (e.g., total running time) of video files started; percent of video completed (total time watched and time into video TRT where exited/skipped); time of day for consumption of video file; Like or Dislike click actions; skip click actions; bitrate at which each video file was streamed; and interaction(s) with the video's progress bar. All such user actions can be logged and stored in database 25 in non-volatile storage.

The server 20 can also be programmed with software 22 so that if a user skips multiple video files in a row, prompts can be displayed on the user device's screen to provide a course correction. For example, if the user skips three or more video files in a row, the server 20 can be programmed so that it sends a display to the user's device, with the display asking the user why the user did not like the videos provided. The display can use tags associated with each of the skipped videos, and/or a list of the titles and/or screen capture images of the skipped videos, to help prompt the user to input more information about what the user did not like about the previously suggested videos. In addition, a display can be sent (or can be included in the same display just discussed) asking the user what the user would like to see more of and providing the tags associated with all video files as examples. In this way, the user can be prompted to expressly provide information as to the user's preferences which can then be used as desired to adjust the points to be assigned to various video files based on tags, team and player preferences, and the like which the user provides in response to such prompts.

The foregoing descriptions have referred to a number of different tags or identifier information associated with each video file. Those skilled in the art will appreciate that the tags can be data files in a variety of forms which can be associated with their corresponding video files in a variety of ways. The following data items shown in Table 4 are examples of the items which can be used as tags or identifiers for some or all of the video files as may be desired.

TABLE 4
Video File Tags/Identifiers

| Tag Category | Tag Sub-Category |
|---|---|
| Source | NFL Network |
| | NFL Films |
| | NFL Now |
| | NFL.com |
| | NFL Club Name (e.g., Arizona Cardinals, |
| | Atlanta Falcons, Baltimore Ravens, Buffalo |
| | Bills, Carolina Panthers, Chicago Bears, |
| | Cincinnati Bengals, Cleveland Browns, Dallas |
| | Cowboys, Denver Broncos, Detroit Lions, |
| | Green Bay Packers, Houston Texans, |
| | Indianapolis Colts, Jacksonville Jaguars, |
| | Kansas City Chiefs, Miami Dolphins, |
| | Minnesota Vikings, New England Patriots, |
| | New Orleans Saints, New York Giants, New |
| | York Jets, Oakland Raiders, Philadelphia |
| | Eagles, Pittsburgh Steelers, San Diego |
| | Chargers, San Francisco 49ers, Seattle |
| | Seahawks, St. Louis Rams, Tampa Bay |
| | Buccaneers, Tennessee Titans, and Washington |
| | Redskins) |
| | Game |
| | Other |
| Type | Highlight |
| | Show |
| | Team Sound |
| | Rundown |
| Show | ((NFL Network Shows)) Fall List |
| | ((NFL Films Shows)) Full List |
| | NFL Now |
| | NFL Now Rundown |
| | NFL Clubs Now |
| | ((NFL.com shows)) Full List |
| Highlight Types | Big Play |
| | Can't Miss Play |
| | Fantasy Highlight |
| | Player Highlight |
| | Show Highlight |
| Event | In-season |
| | Playoffs |
| | Superbowl |
| | Pro Bowl |
| | Offseason |
| | Senior Bowl |
| | Combine |
| | Draft |
| | Preseason |
| | Training Camp |
| Players | All active players listed individually |
| | All historical players listed individually |
| Persons | ((All NFL Network Talent)) |
| | Other Celebrities/known-persons outside of |
| | NFL (to be added on ad hoc basis) |
| Topic | Game Preview |
| | Analysis |
| | Interview |
| | Comedy |
| | News |
| | Countdown |
| | Community/Charity |
| | Lifestyle |
| | Celebrity |
| | Feature |
| | Locker Room Sound |
| | Press Conference |
| | Bloopers/Follies/Fun |
| | Podcast/Radio |
| Entitlement | Free |
| | Registered |

As indicated in FIG. 1, a variety of devices 1-6 can be used to access the computer server 20 and view the video files stored in the video database 25. Those skilled in the art will appreciate that any one user may in fact use a number of different devices to access the computer server 20. For example, a given user may have a phone 5 and a table 4 which the user may use at different times to access the computer server 20 and view video files at home or while at other locations, and may use a computer 2 while at work (e.g., during a lunch break) to access the server 20 and view video files. It will be appreciated that in one embodiment, the user profile for such a user may include information relevant to each of the devices used by the user at different times. In such a situation, the computer server 20 may be programmed so that it keeps track of the video files viewed on any of the user's devices, as well as videos transmitted to any of the user's devices but skipped, or partially watched and then skipped, as well as the point reached in a video file which was being viewed on any of the user's devices when the connection between the device and the computer server 20 was terminated or lost. When the user next accesses the computer server 20 on any of the devices associated with that user, the computer server 20 may be programmed so that, once it recognizes the user and checks the associated user profile, the computer server 20 retrieves the interrupted video file that was being viewed during the user's last session and transmits that video file at the point where it had last been viewed. Alternatively, the computer server 20 can transmit the video file beginning a short time before the point at which viewing had been interrupted, such as a minute, five minutes, or shorter or longer as may be desired. Those skilled in the art will appreciate that the amount of the video file to be transmitted to the user in advance of the point at which viewing was previously interrupted in such a situation can also vary depending on the user's preferences, the type of video file involved, the nature of the video file's content, the amount of the video file previously viewed or left to be viewed, and the like. This approach offers the advantage of allowing a user to view the video files essentially seamlessly across different devices that the user may prefer to use.

In one embodiment, the computer server 20 is programmed by software 22 to determine the type of operating system or other information about the device used by the user to access the computer server 20 and, depending on the type of platform (e.g., operating system, processor, memory capabilities, etc.) used by the user to access the server 20, may adjust the points for various types of video files, such as to give priority to shorter video files for certain types of devices. For example, the server 20 may be programmed so that, when a phone or tablet operating system is detected, the server 20 also determines whether the connection via the network 10 is a 3G cellular, LTE cellular, or Wi-Fi connection and, if a Wi-Fi connection is detected to add additional points to the aggregate point total for video files that are 20 minutes or longer, whereas if a 3G or LTE cellular connection is detected, but no Wi-Fi connection is used, additional points can be added to the aggregate point totals for video files that are less than seven minutes or so in length. Such point allocations can also vary depending on the amount of memory needed to store the video file and the connection detected. Similarly, different points can be added (or subtracted) to a video file's aggregate total of points depending on the nature of the video, the nature of the connection or user platform, and the time of day when the user accesses the server 20. For example, it may be that additional points are added to shorter video files if the connection detected is a 3G or LTE cellular telephone connection and if the connection is between the hours of 8 a.m. and 7 p.m. in a time zone, but no additional points are added if the connection between the user device and the server 20 is made after 7 p.m. in a given time zone.

In one embodiment, a user may be offered the ability to upgrade the user's level of service, such as by obtaining access to additional video files, obtaining the ability to download files, obtaining greater bandwidth, obtaining a priority allocation of computer server 20 resources, or the like, in exchange for a payment, such as by an online credit card, PayPal or other form of online payment, for example. Such option for a higher level of service may include more than two levels of service (e.g., a free level of service and a paying level of service). For example, a given level of service may include greater access to a particular team's collection of video files, may provide access to particular video files sooner than they become available otherwise, and the like. In addition, those skilled in the art will appreciate that the computer server 20 may be programmed so that it does not present an initial ad or commercial to a paying user, or otherwise subject the paying user to commercials. Those skilled in the art will appreciate that the computer server 20 can be operable to accept and verify online payments for enhanced service and automatically authorize such enhanced service as may correspond to a particular payment in any one of a number of conventional ways.

Although not shown, those skilled in the art will appreciate that a search function can be provided by software on server 20 for the information and video files in database 25 and video database 30. For example, a user can be presented with a “Search” bar on the user's device (such as any of devices 1-6) which allows the user to enter any information desired by user, such as alphanumeric information or standard characters, which is then transmitted as a search request to the server 20. The server 20 receives the search request and performs a search of database 25 and video database 30 for matching strings. The server 20 can also retrieve information from the user's profile to determine the user's favorites and preferences previously indicated, prior viewing history and log information, prior likes and dislikes, and the like as described above. The server 20 can then sort and rank the video files and information which match the search received from the user to rank the matching video files and transmit a list of the matching video files with the highest ranked matching video files listed first. Of course, it may be desirable to provide a list of ranked video files to the user that is limited to say, no more than five or ten video files. Instead of a list, the server 20 can begin streaming the highest ranked video file to the user's device which sent the request and also provide a list of the next five or so highest ranked videos so the user can simply click on any one of the next five or so video links to view the corresponding video file (and can interrupt the streaming video in this example or simply wait until it ends before clicking on the link to another video file to view the same).

The foregoing detailed descriptions and disclosure are only illustrative and by way of examples. Those skilled in the art will appreciate that the foregoing embodiments can be changed and arranged in different ways, and can be implemented in a variety of ways, all without going beyond the scope and spirit of the invention which is set forth in the claims below. For example, those skilled in the art will appreciate that a listing of video files need not actually contain a list of titles of video files or the video files themselves, but may instead any data indicating the video files, such as alphanumeric or other identifiers, date or time identifiers, uniquely assigned numeric or other identifiers, or addresses or indirect addresses for the video files. Those skilled in the art will appreciate as well that a variety of video and audiovisual file formats may be used in accordance with the foregoing disclosure, such as, for example, .mp4, .mv4, .avi, .mpg, .mpeg, .flv, .mkv, and other video file formats, and may include video files with various resolutions, such as both high and low resolution videos. Those skilled in the art will also appreciate that various types of components, such as for example, controllers, computer servers, operating systems, and video displays, may be used as may be desired.

Moreover, those skilled in the art will appreciate that, although the foregoing detailed description and examples and illustrations have used video files as examples, the invention need not be so limited. For example, in lieu of or in addition to video files, the systems and methods of an embodiment could include text, graphics, photographs, artwork, cartoons and animations, and other types of information and data of interest to users and related to user preferences. For example, a user might indicate a preference for photos of birds versus sharks or other animals, or might indicate a preference for photos of wildlife instead of landscapes, and so forth.

In addition, while the foregoing disclosure has used a particular type of sporting event as an example, those skilled in the art will appreciate that the systems and methods described herein will find useful application in a variety of fields in which the personalization and delivery of video and/or information may be useful. For example, the present disclosure may be useful in connection with other subject matter, such as hobbies or interests, or other events, such as other types of sporting events, concerts, rallies, speeches, pageants, and the like, and in connection with fields such as television and movies. Thus, it will be appreciated that the foregoing descriptions and the figures are illustrative only, and not limiting.

We claim:

1. A computer system for providing video files comprising:
a video database comprising a plurality of video files and information associated with each of the plurality of video files;
a user database comprising a plurality of user profiles, each user profile comprising information associated with a corresponding user;
at least one computer server in communication with the video database and user database and connected to at least one computer network;
software executable on said at least one computer server, with the software operable to receive requests for information from at least one second computer in said computer network, check to determine if the second computer requesting information is associated with an existing user profile and, if the second computer requesting information is associated with an existing user profile, generate a listing of a plurality of video files of potential interest to a user associated with the user profile, generate a ranking of the video files in the listing based at least in part on the time between the publication of at least one of the video files and the time of the request by the second computer in the network, retrieve information associated with a plurality of the highest ranked video files from the video database, transmit the information associated with the plurality of video files to the second computer, and transmit the at least one of the video files to the second computer.

2. The computer system according to claim 1 wherein the computer network comprises the Internet.

3. The computer system according to claim 1 wherein the user profile comprises at least one preselected sports team.

4. The computer system according to claim 3 wherein the user profile further comprises at least one preselected person.

5. The computer system according to claim 4 wherein the user profile further comprises at least one preselected category of video file.

6. The computer system according to claim 5 wherein the user profile further comprises at least one preselected category of subject.

7. The computer system according to claim 3 wherein the user profile further comprises a log of a plurality of video files which have been previously transmitted to a computer associated with the user profile and for which a positive response was previously received by the computer server.

8. The computer system according to claim 1 wherein the ranking of the plurality of video files is further based at least in part of the subject matter of the video files, at least one sports team appearing in the video files, and at least one or more person appearing in the video files, wherein the sports team and the player correspond to a team and a person included in the user profile for the computer requesting the information.

9. The computer system according to claim 8 wherein the sports team comprises a professional football team, the person comprises a professional football player, and the subject matter comprises at least one of the following types of subject matter: touchdown, sack, blitz, reception, first down, penalty, interception, fumble, tackle, block, blocked pass, hit, run, score, punt, punt return, kickoff, kickoff return, point after touchdown, pass, field goal, preseason, regular season, playoff, superbowl.

10. The computer system according to claim 9 wherein the ranking of video files is based on assigning different values to different video files based at least in part on one or more categories of subject matter of the corresponding video files and an elapsed time between the publication of each of the video files and the time the second computer requests information from the computer server, with at least one category of subject matter associated with a higher value than at least one other category of subject matter.

11. The computer system according to claim 1 wherein the second computer is any one of the following types of computing devices: desktop computer, laptop computer, videogame console, tablet, or phone.

12. The computer system according to claim 11 wherein the software is operable to generate a log of video files and related information most recently transmitted to the second computer and, if the connection between the second computer and the computer server ended while a video file was being played on the second computer, a point during the video file at which the playing of the video file ceased when the connection was ended.

13. The computer system according to claim 12 wherein said video database comprises data about a first group of video files, wherein the first group of video files comprises video files each of which has a publication date more recent than video files stored in said video database and not in the first group of video files.

14. The computer system according to claim 13 wherein said software executable on said computer server is operable to search the data about the first group of video files to generate the ranking of the plurality of video files of potential interest to the user.

15. The computer system according to claim 14 wherein said computer server further comprises software operable to receive a first plurality of video files and information regarding the first plurality of video files from one or more authorized computing devices via the computer network and store the first plurality of video files and information regarding the first plurality of video files in said video database.

16. The computer system according to claim 13 wherein the first group of video files comprises a range of between 50 and 50,000 video files.

17. The computer system according to claim 13 wherein the first group of video files comprises a range of between 100 and 25,000 video files.

18. The computer system according to claim 13 wherein the first group of video files comprises a range of between 500 and 1,500 video files.

19. A computer system for viewing video files comprising:
a computing device in communication with a computer network, and having a display, a processor, a memory, and a user input system;
software executable on said computing device, with the software operable to transmit a request for information to the network and, via the network, to a computer server, to receive a response from the computer server, wherein if said computing device and displayed on said computing device is associated with an existing user profile accessible by the computer server, the computer server transmits to said computing device a listing of a plurality of video files of potential interest to a user associated with the user profile, wherein the listing of the plurality of video files is ranked in an order based at least in part on the time between the publication of at least one of the plurality of video files and the time of the request by said computing device, to receive information associated with a plurality of the highest ranked video files from the computer server, to transmit a second request from said computing device in response to a user input, and to receive in response to the second request at least one of such video files, and to display the at least one of such video files on said computing device.

20. The computer system according to claim 19 wherein said computing device comprises any one of the following: desktop computer, laptop computer, videogame console, tablet, or phone.

21. The computer system according to claim 20 further comprising software operable to allow a user to input preference information comprising information about one or more sports teams, one or more players, and one or more categories of video files, to transmit the preference information to a computer server for generating a user profile, and operable to receive one or more video files from the computer server responsive to a user profile comprising the preference information.

22. A computer system for providing video files comprising:
a database comprising a plurality of video files, information associated with each of the plurality of video files, and information associated with a plurality of users;
at least one computer server in communication with said database and connected to at least one computer network;
software executable on said at least one computer server, with the software operable to receive requests for information from at least one second computer in said computer network, check to determine if the second computer requesting information is associated with an existing user profile stored in said database and, if the second computer requesting information is associated with an existing user profile, generate a ranking of a plurality of video files of potential interest to the user based at least in part on the time between the publication of at least one of the video files and the time of the request by the second computer in the network, retrieve information associated with a plurality of the highest ranked video files from the database, and transmit the information associated with the plurality of video files to the second computer.

23. The computer system according to claim 22 wherein the software is operable to, in response to a second request from the second computer requesting at least one of such video files, transmit the at least one of the video files requested to the second computer requesting the video file in the computer network.

24. The computer system according to claim 22 wherein the information associated with the plurality of video files further comprises at least a portion of one of the video files and a title associated with the one of the video files.

25. The computer system according to claim 22 wherein said database comprises a video database and a user database, wherein said video database comprises a plurality of video files and information associated with the video files stored in non-volatile memory, and wherein said user database comprises information associated with a plurality of users stored in non-volatile memory.

26. The computer system according to claim 25 wherein the information associated with a plurality of users comprises information regarding user preferences.
